(19) United States
(12) Patent Application Publication
(10) Pub. No.: US 2008/0223729 A1
(43) Pub. Date: Sep. 18, 2008

(54) Electrolytic activation of fluids

(76) Inventor: Rodolfo Antonio M. Gomez, Urrbrae (AU)

Correspondence Address: KLAUBER & JACKSON, 411 HACKENSACK AVENUE, HACKENSACK, NJ, 07601, US

(21) Appl. No.: 12/074,385

(22) Filed: Mar. 3, 2008

Related U.S. Application Data
(63) Continuation of application No. 10/480,412, filed on Dec. 10, 2003, now abandoned.

(30) Foreign Application Priority Data
Jun. 14, 2001 (AU) PR5667

(51) Int. Cl. C02F 1/461

(52) U.S. Cl. 205/687; 204/253; 204/267

(57) ABSTRACT

A unipolar liquid activation apparatus with an anode cell (40), a cathode cell (41), and a direct current power supply (43), the anode cell having an anode (46), a liquid inlet (50) and an anolyte outlet (51), the cathode cell having a cathode (47), a liquid inlet (52) and a catholyte outlet (53), means to electrically connect the anode and cathode respectively to the direct current power supply. The cells can also include connected solution electrodes (44, 49). Alternatively the anode and cathode can be compound electrodes (81, 83) with means to electrically connect the inner anode electrode and the inner cathode electrode. The anode cell and cathode cell may be adjacent to each other and electrically connected by an electronic membrane (104) in contact respectively with the anode and cathode and allowing flow of electrons only from the cathode to the anode. The unipolar activation apparatus may also be an anode (141) and a cathode (142) electrically isolated from each other but connected to a DC power source.

### FIELD OF INVENTION

This invention concerns apparatus and process to carry out electrolytic unipolar activation of fluids also known as unbalanced electrolysis.

### BACKGROUND AND PRIOR ART

In a conventional electrolytic reaction in a conventional diaphragm cell, electrons are removed from the anode electrode resulting in an oxidation reaction at the anode cell. The ions produced at the anode electrode migrate through the diaphragm to the cathode electrode due to difference in concentration of ions. The ions are reduced at the cathode completing the ionic circuit of the diaphragm cell. The slow movement of ions is often sped up by transferring the anolyte from the anode cell to the cathode cell. The complete electronic circuit of the diaphragm cell is shown on FIG. 1.

FIG. 1 is a conventional diaphragm electrolytic cell where a DC source 1 is connected to the anode electrode 2 and cathode electrode 3 with a diaphragm 4 separating the anode cell 7 and anode electrode 2 from the cathode cell 8 and cathode electrode 3. The complete electronic circuit passes from the anode electrode 2 to the DC source 1 to the cathode electrode 3 through the catholyte 5 through the diaphragm 4 through the anolyte 6 and to the anode electrode 2.

The activation of liquids by subjecting the liquid to unipolar activation or unbalanced electrolysis is becoming a major branch of chemistry. The subject has been studied extensively in Russia and some of the studies have been published by Dr. Vitold Bakhir in several papers. Dr. Bakhir, et al have been granted U.S. Pat. No. 5,427,667 (Jun. 27, 1995) for an apparatus for the electrochemical treatment of water, with the objective of sterilizing the water or using the product as a disinfectant. Dr. Bakhir's apparatus is tubular in shape and is diagrammatically shown in FIG. 2.

FIG. 2 is a diagram of a tubular diaphragm cell described in Dr. Bakhir's U.S. Pat. No. 5,427,667. The outer tube 10 is cathode electrode and the inner tube 11 is the anode electrode and these are separated by a cylindrical ceramic diaphragm 12. The DC power source is not shown but is connected to the anode electrode and the cathode electrode. Liquid 13 to be activated is fed into the outer cell and exits as activated catholyte 14. Further liquid 15 to be activated is fed into the inner cell and exits as activated anolyte 16. Alternatively the outer tube may be the cathode electrode and the inner tube may be the anode electrode. The electrodes are, as discussed in relation to the simple electrochemical cell above, separated by a ion permeable diaphragm. Liquid is fed into the outer tube and is discharged as the catholyte and a separate liquid is fed into the inner tube and is discharged as the anolyte. There is no mixing of the liquids and the apparatus acts to remove electrons from the anolyte and add electrons to the catholyte.

While the major application of Dr. Bakhir's apparatus is the treatment of water, the application of unbalanced electrochemical activation is very extensive as described in the papers of Dr. Bakhir. The benefits of unipolar activation can be examined in almost every commercial application in energy, health, agriculture, environment, and general industries. The only limitation in most cases is the use of a diaphragm between the anode and cathode electrodes that limit reaction rates due to the impedance of the diaphragm and problems from blockage of the diaphragm from solids and salt formation.

Our company has been granted Australian patents 654774 (Mar. 29, 1993), 707701 (Oct. 28, 1999) and U.S. Pat. Nos. 5,569,370 (Oct. 29, 1996), 5,882,502 (Mar. 16, 1999) regarding an electrolytic cell that does not use a diaphragm or membrane between the anode and the cathode electrodes. This electrolytic cell has a very high Faraday efficiency, a higher energy efficiency and faster reaction rate than conventional diaphragm cells allowing this electrolytic cell to be used in commercial applications particularly where the use of a diaphragm is a disadvantage because of blockage of the diaphragm from solid particles, deposits of salts or oily electrolytes. This is illustrated in FIG. 3.

FIG. 3 shows the electrolytic system covered in U.S. Pat. No. 5,882,502 where electrolysis is carried out without a diaphragm between the anode electrode and the cathode electrode. The anode cell 20 is separate from the cathode cell 21. The complete electronic circuit starts from the anode electrode 22 to the DC power source 23 to the cathode electrode 24 through the catholyte 25 to the cathode solution electrode 26 to the anode solution electrode 27 through the anolyte 28 and to the anode electrode 22. Ions produced at the anode cell in the anolyte are transferred 29 with the anolyte to the cathode cell and the reduced catholyte is returned 19 to the anode cell to provide the ionic circuit of the system.

### DESCRIPTION OF THE INVENTION

Unipolar activation involves only the transfer of electrons from the anode to the cathode electrodes and there is no ionic circuit as in conventional electrolytic reactions. However, there is usually a complete electronic circuit between the anode electrode, the DC power source, and the cathode electrode. Part of this invention is an apparatus where unipolar activation is carried out without a complete electronic circuit. The unipolar activation system must also accommodate features such as high reaction rates, energy efficiency, pressure, temperature, mixtures of liquids, liquids and gases, or liquids and solids required for commercial applications. These features are best accommodated in electrolytic systems where the anode cell is separate from the cathode cell and with the absence of a diaphragm.

In one form therefore the invention is said to reside in a unipolar liquid activation apparatus including an anode cell, a cathode cell, and a direct current power supply, the anode cell having an anode, a liquid inlet and an anolyte outlet, the cathode cell having an cathode, a liquid inlet and a catholyte outlet, means to electrically connect the anode and cathode respectively to the direct current power supply, means to supply fluid to the anode and cathode cells, and means to recover the activated anolyte from the anode cell and the activated catholyte from the cathode cell.

In one embodiment the anode cell further includes a first solution electrode and the cathode cell includes a second solution electrode and further including means to electrically connect the first solution electrode and the second solution electrode.

In an alternative embodiment the anode is a compound anode, the compound anode having an inner anode electrode and an outer electrode being the anode and separated by and in intimate contact with an electrolytic membrane or internal electrolyte, the cathode is a compound cathode, the compound cathode having an inner cathode electrode and a outer electrode being the cathode and separated by and in intimate contact with an electrolytic membrane or internal electrolyte and means to electrically connect the inner anode electrode to the inner cathode electrode.

Alternatively the anode cell and cathode cell are adjacent to each other and the first and second solution electrodes and the means to electrically connect the first solution electrode and the second solution electrode together comprise a common first and second solution electrode being an electronic membrane in contact respectively with the anode and cathode and allowing flow of electrons only from the cathode to the anode.

The electrical resistance of the electronic membrane in contact with the anode and cathode electrode may be very high resulting in the anode electrode being electrically isolated from the cathode electrode.

Preferably the anode electrode and the cathode electrode are cylindrical incorporating internal surface enhancement features such as gauze or expanded metal connected to the electrodes.

Preferably the positive terminal of the DC power source is connected to the anode electrode and the negative positive terminal of the DC power source is connected to the cathode electrode and the ends of the anode and cathode electrodes may be connected to electrically non-conducting inlet and outlet.

The means to supply fluid to the anode and cathode cells may includes means to feed at least one of a liquid, a gas or a solid or a mixture thereof.

The means to electrically connect the first solution electrode and the second solution electrode is a wire between the respective cells.

Preferably the cathode and anode have a high surface area to increase the contact area with the respective liquids.

In an alternative form the invention is said to reside in a method of sterilisation of liquid including the step of passing streams of the liquid through respective electrolytic cells, the electrolytic cells being an anode cell having an anode, a liquid inlet and an anolyte outlet and a cathode cell having an cathode, a liquid inlet and a catholyte outlet, a direct current power supply electrically connected to the anode and cathode respectively,

means to supply liquid to the anode and cathode cells, and
means to recover the activated anolyte from the anode cell and the activated catholyte from the cathode cell.

Hence it will be seen that the apparatus performs its function of removing electrons from fluid at the anode and adding electrons to the fluid in the cathode without the use of a diaphragm or membrane in contact with the fluids when a direct current power is applied to the anode and cathode electrodes. The absence of a diaphragm allows fast reaction rate that is required for commercial applications. The other unipolar activation apparatus removes electrons from the anode solution and adds electrons to the cathode solution from a DC power source but in this apparatus, the anode solution is completely electrically separate from the cathode solution. The invention has important commercial applications in energy, environment, agriculture, health, chemical and general industries.

The invention may have three separate embodiments of electrochemical systems that may be used in commercial applications of unipolar activation. Two involve unipolar activation where there is a complete electronic circuit while the third apparatus does not have a complete electronic circuit. These apparatus may be used for unipolar activation of single liquids such as water, mixtures of liquids, liquid and gas, or liquid and solids.

This then generally describes the invention but to assist with understanding reference will now be made to the accompanying drawings and examples.

In the drawings:

FIG. 1 shows a prior art a conventional diaphragm electrolytic cell;

FIG. 2 shows a diagram of a prior art tubular diaphragm cell described in Dr. Bakhir's U.S. Pat. No. 5,427,667;

FIG. 3 shows a prior art electrolytic system covered in U.S. Pat. No. 5,882,502;

FIG. 4 shows a first embodiment of the invention being an electrochemical system for unipolar activation;

FIG. 5 shows a second embodiment of the invention as an experimental apparatus built to examine the unipolar activation of water for use as disinfectant in cooling tower water;

FIG. 6 shows a further embodiment of the invention of an electrochemical system for unipolar activation using a compound electrode system;

FIG. 7 shows a further embodiment of the invention of an electrochemical system for unipolar activation;

FIG. 8 shows a further embodiment of the invention of an electrochemical system for unipolar activation with the anode electrically isolated from the cathode; and

FIG. 9 shows a diagram of a commercial unit following the principles shown in FIG. 8.

### DESCRIPTION OF PREFERRED EMBODIMENTS AND THE DRAWINGS

FIG. 4 is a diagram showing an electrolytic system for unipolar activation of fluids with a solution electrode adjacent to each of the anode electrode and cathode electrode. The function of this system is to remove electrons from the fluid in the anode cell and to add electrons to the fluid in the cathode cell. The anode cell 40 is separate from the cathode cell 41. The complete electronic circuit starts from the anode electrode 46 to the DC power source 43 to the cathode electrode 47 through the catholyte 48 to the cathode solution electrode 49 via the electrical link 56 to the anode solution electrode 44 through the anolyte 45 and to the anode electrode 46. There is no transfer of ions between the anode cell and the cathode cell. Liquid 50 is fed to the anode cell and is discharged as activated anolyte 51. Liquid 52 is fed to the cathode cell and is discharged as activated catholyte 53. Desired chemical reactions may be achieved by the system shown on FIG. 4 by adding chemicals, gas, another liquid, or fine solids 54 to the anode cell or 55 to the cathode cell. For instance, the production of hydrogen peroxide in the activation of water may be increased by adding oxygen to the cathode.

FIG. 5 is a diagram of a large laboratory apparatus to carry out water activation. The anode circuit is separate from the cathode circuit except for the connection with the DC power source 70 and the solution electrodes. The anode liquid is circulated from a heated anode pump box 60 by a variable speed pump 61 to a temperature controlled heater 62 to a 50 mm diameter×228 mm long titanium tube anode 63 with a 25 mm diameter×368 mm long titanium tube anode solution electrode 64 and then returned to the heated anode pump box 60. The cathode liquid is circulated from a heated cathode pump box 65 by a variable speed pump 66 to a temperature controlled heater 67 to a 50 mm diameter×228 long titanium tube cathode 68 with a 38 mm diameter×368 mm long titanium tube cathode solution electrode 69 and then returned to the heated cathode pump box 65. The positive terminal of the DC power source 70 is connected to the anode electrode 63 and the negative terminal is connected to the cathode electrode 68. The anode solution electrode 64 is connected to the cathode solution electrode 69 by electrical link 71. The pH of the anode liquid and the cathode liquid were measured regularly by a calibrated EUTECH pH FM1 pH meter. Liquids may be activated at different liquid composition, different voltage and current, and different activation periods.

FIG. 6 is a diagram of a system for carrying out unipolar activation using compound electrodes. The anode compound electrode 81 is located in the anode cell 80 and the cathode compound electrode 83 is located in the cathode cell 82. The anode compound electrode 81 consists of an outer anode electrode 84 that is in contact with the anolyte 87 and an inner anode electrode 85 in contact with the outer anode electrode 84 through an internal solution or gel or electronic membrane 86 that allows current to flow from the internal anode electrode 85 to the outer anode electrode 84. The cathode compound electrode 83 consists of an outer cathode electrode 88 that is in contact with the catholyte 91 and an inner cathode electrode 89 in contact with the outer cathode electrode through an internal solution or gel or electronic membrane 90 that allows current to flow from the outer cathode electrode 88 to the inner cathode electrode 89. The positive terminal of the DC power source 92 is connected to the outer anode electrode 84 while the negative terminal is connected to the outer cathode electrode 88. The inner cathode electrode 89 is connected to the inner anode electrode 85 by an electrical link 99. Liquid 93 is fed to the anode cell 80 and exits the anode cell as activated anolyte 94. Liquid 95 is fed into the cathode cell 82 and is discharged as activated catholyte 96. Other chemicals such as liquids, gases, or fine solids 97 may be fed into the anode cell or 98 to the cathode cell to achieve desired reactions.

FIG. 7 is a diagram showing an electrolytic cell with the anode electrode and the cathode electrode having a common wall. The anode cell 100 has a common wall 101 with the cathode cell 102. The anode electrode 103 is located in the anode cell in contact with the anolyte 108 and connected electrically to the cathode electrode 105 by an electrolytic membrane or internal electrolyte or gel or ceramic conductor 104. The cathode electrode is in contact with the catholyte 107. The positive terminal of the DC power source 106 is connected to the anode electrode 103 while the negative terminal is connected to the cathode electrode 105. Liquid 109 is fed to the anode cell 100 and is discharged as activated anolyte 110. Liquid 111 is fed to the cathode cell 102 and is discharged as activated catholyte 112. In this embodiment the electrolytic membrane or internal electrolyte or gel or ceramic conductor 104 acts as the respective solution electrodes and electrical link of the earlier embodiments.

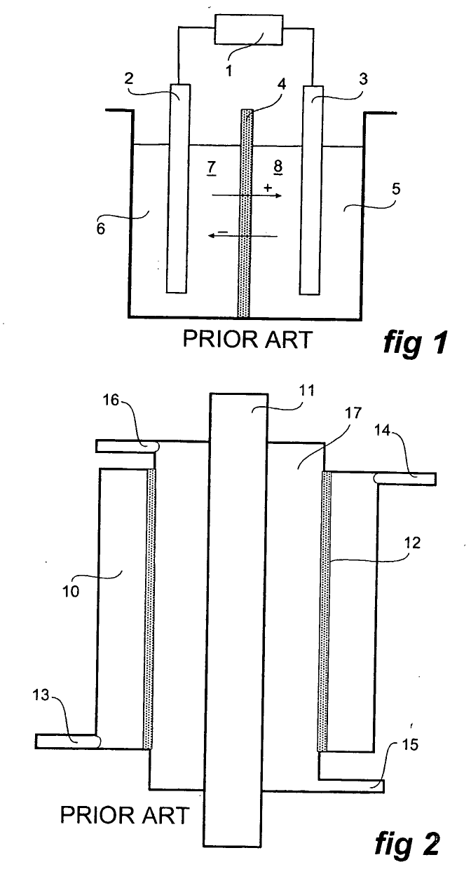

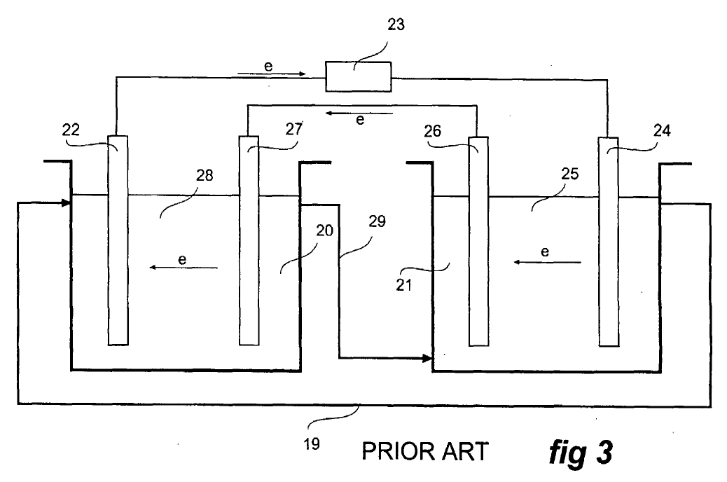

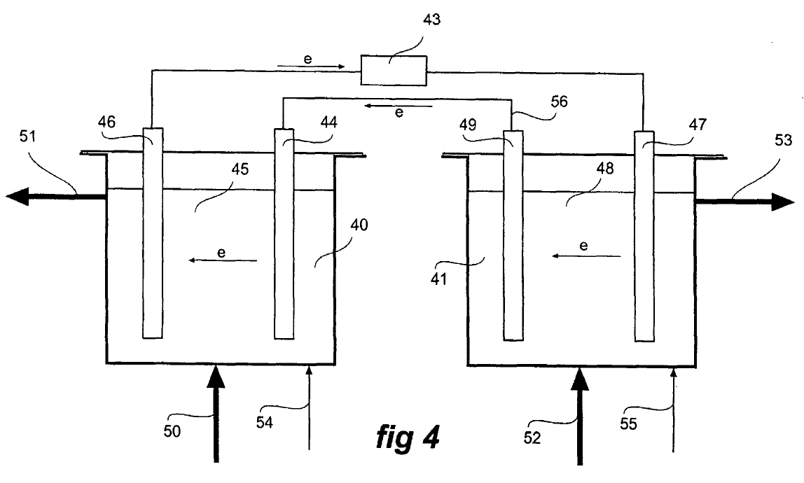

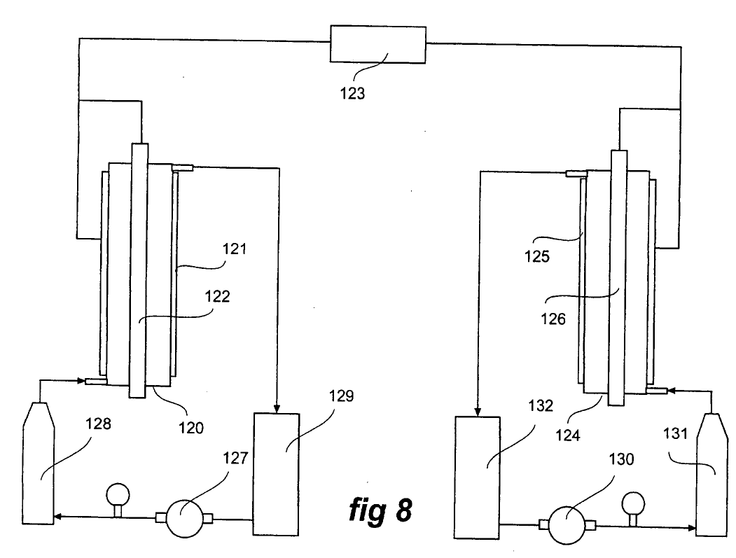

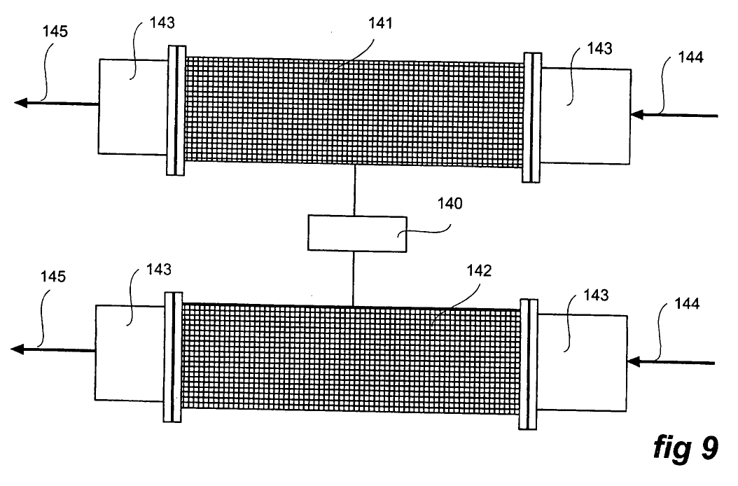

The unipolar apparatus in FIG. 8 is similar in principle to the apparatus shown on FIG. 7 if the electrical resistance of the membrane 104 is increased to infinity. The result is that the anode electrode and the cathode electrodes are electrically isolated from each other. In FIG. 8, the anode cell 120 consists of the outer anode cell 121 of 50 mm diameter×228 mm long titanium tube internally coated with platinum, ruthenium and rhodium and a further anode electrode 122 of 38 mm diameter titanium tube coated with platinum ruthenium and rhodium both connected to the positive of the DC power source 123. The cathode cell 124 consists of the outer cathode cell 125 of 50 mm diameter×228 mm long titanium tube internally coated with platinum, ruthenium and rhodium and further cathode electrode 126 of 38 mm diameter titanium tube coated with platinum ruthenium and rhodium both connected to the negative of the DC power source 123. Variable speed pump 127 circulates the anode liquid through heater 128 through anode electrode 120 and anode pump box 129. Variable speed pump 130 circulates the cathode liquid through heater 131, through cathode cell 124 and cathode pump box 132. Not shown is EUTECH pH FM1 pH meter to measure the pH regularly. The apparatus shown on FIG. 8 was used to obtain the data in Table 4 below.

FIG. 9 is a diagram of a commercial unit following the principle shown in FIG. 8 where the anode electrode is electrically isolated from the cathode electrode. The anode electrode 141 is a tube or a pipe made of a conducting material and incorporate surface increasing features such as gauze or expanded metal connected to the tube electrode not only to increase the surface area of the electrode but also to ensure intimate contact between the fluid and the electrode. The internal surface of the electrode may be coated with a material for corrosion protection as well as reduction of electrode over-voltage. The cathode electrode is 142 is similarly constructed. Where high voltage is applied, the outer surfaces of the anode and cathode electrodes may be covered with an electrical insulation. The anode electrode is connected to the positive of the DC power source 140 and the negative of the DC power source 140 is connected to the cathode electrode. The ends of the anode and cathode electrodes are connected to electrically non-conducting pieces 143.

### EXPERIMENTAL RESULTS

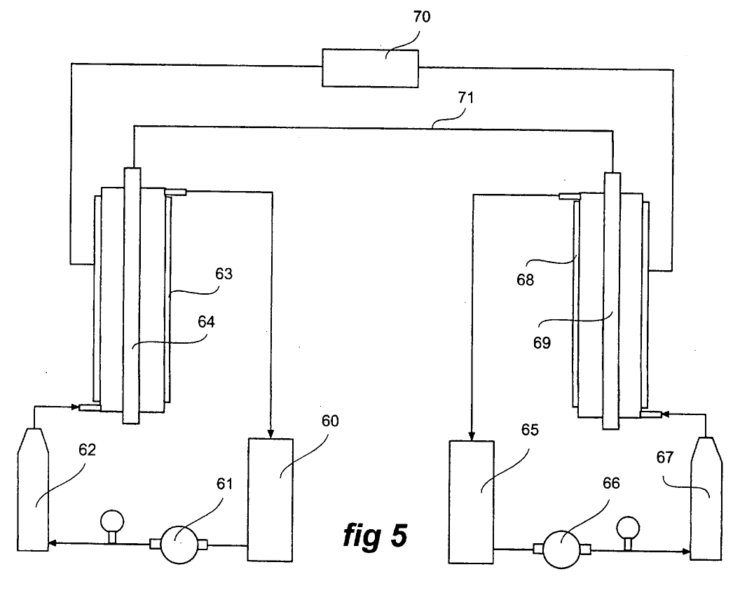

As discussed above FIG. 5 is an experimental apparatus built to examine the unipolar activation of water for use as disinfectant in cooling tower water to control legionella bacteria and sterilizing all water used in hospitals to help control bacteria that have become resistant to antibiotics. The DC power source 70 has an 18 volts DC-20 amperes capacity. The anode electrode 63 is a 50-millimetre (mm) diameter×228-mm long titanium tube internally coated with platinum, ruthenium and rhodium and the anode solution electrode 64 is 25-mm diameter titanium tube coated externally with platinum, ruthenium, and rhodium. The cathode electrode 68 is a 50-mm diameter×228-mm long titanium tube internally coated with platinum, ruthenium and rhodium and the cathode solution electrode 69 is 38-mm diameter titanium tube coated externally with platinum, ruthenium, and rhodium. The apparatus is fitted with variable speed circulating pumps, pressure gauges, heaters controlled by temperature indicating controllers with liquid pH at the cathode and anode measured regularly by a EUTECH pH FM1 pH meter calibrated before each run to 7.01, 10.01, and 4.01 pH standard solutions. Voltage between the anode electrode and the anode solution electrode (anode voltage) and the cathode solution electrode and the cathode electrode (cathode voltage) were measured regularly. Adelaide tap water at room temperature was used for the water sterilization test while Adelaide tap water at 50 degrees Celsius with a minute amount of sodium chloride to simulate commercial conditions, were used in the cooling water disinfection test. The anode and cathode circuits each accommodated 5 litres of liquid. Adelaide tap water would contain very minute amounts of chlorine, iron, calcium and aluminium sulfates. The experimental results were:

TABLE 1
Disinfection of Water for a Cooling Tower (Temperature 50 C.)
Adelaide Tap Water with 3 grams per liter of sodium chloride

| | | | | | | |
|---|---|---|---|---|---|---|
| Cell Voltage | 9.0 | 9.0 | 9.0 | 9.0 | 9.0 | 9.0 |
| Cell Amperes | 0.63 | 0.66 | 0.69 | 0.65 | 0.73 | 0.67 |
| Time (minutes) | 0 | 60 | 120 | 180 | 270 | 556 |
| Anode Voltage | 3.38 | 2.83 | 2.84 | 2.79 | 2.85 | 2.85 |
| Cathode Voltage | 5.64 | 6.12 | 6.18 | 6.22 | 6.15 | 6.17 |
| Anode Liquid pH | 7.7 | 6.8 | 6.5 | 6.4 | 6.1 | 4.3 |
| Cathode Liquid pH | 8.1 | 8.1 | 8.0 | 8.0 | 7.9 | 7.9 |

The pH of Adelaide tap water with the sodium chloride is 7.0 to 7.1 measured before being charged into the apparatus. The pH of the liquid changed while it was being heated in the apparatus. A voltage of 0.453 volts was detected between the anode and the cathode electrode during heating up and this may explain the change in the pH of the water before DC power was applied to the electrodes. Nevertheless, if the starting pH of the liquid was 7.1, the anode liquid became acidic while the cathode liquid became alkaline. The results conform to the published data of Dr. Bakhir that the anolyte became acidic (pH range of 0.025 to 7) while the catholyte became alkaline (pH range of 7.50 to 13.0). Test are now in progress to test the effect of the catholyte and anolyte from this experiment on legionella bacteria.

TABLE 2
Sterilization Test on Adelaide Tap
Water (Temperature 25 to 26 C.)

Time

| | 0 | 360 minutes |
|---|---|---|
| Cell Voltage | 18.0 | 18.0 |
| Cell Amperes | 0.20 | 0.26 |
| Anode Voltage | 4.1 | 4.3 |
| Cathode Voltage | 13.9 | 13.7 |
| Anode Liquid pH | 6.9 | 6.0 |
| Cathode Liquid pH | 6.9 | 8.2 |

The anode liquid became acidic while the cathode liquid became alkaline. Although chemical analysis of the products was not carried out, the pH of the products from the anode and the cathode followed Dr. Bakhir's published data. The smell of the products also indicated the presence of hydrogen peroxide.

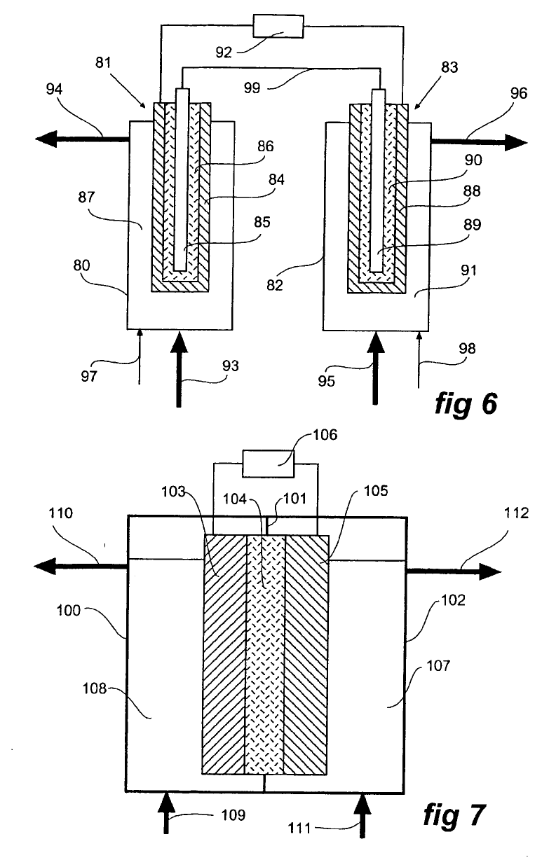

Unipolar electrolytic activation may also be carried out using compound electrode as shown on FIG. 6. The feature of the compound electrode is that only the anode electrode 81 and the cathode electrode 83 are in contact with the anode and cathode liquids respectively but a complete electronic circuit is still achieved. The complete electronic flow is from the anode electrode 84 to the DC power source 92 to the cathode electrode 88 through the cathode electronic membrane or internal catholyte 90 to the cathode internal electrode 89 to the anode internal electrode 85 through the anode electronic membrane or internal anolyte 86 to the anode electrode 84. The electronic membrane 86 at the anode electrode allows the flow of electrons from the anode internal electrode to the anode electrode. At the cathode electrode, the electronic membrane 90 allows the flow of electrons from the cathode electrode to the cathode internal electrode. A preliminary experiment was carried out using cubical electrodes made of 316 stainless steel. The anode electrode is 38.33 millimetres wide×88.96 millimetres long (inside) in cross section×250 millimetres deep. The internal anode solution electrode is 29.31 mm wide×79.87 long to give a gap of about 4.5 mm. The cathode electrode is 38.42 mm wide×88.7 mm long (inside) in cross section×250 mm deep. The internal cathode solution electrode is 19.71 mm wide×69.38 mm long to give a gap of about 9.3 mm. A weak potassium hydroxide solution with a pH of 13.7 was used as the internal electrolyte for the anode and the cathode. Adelaide tap water was used in the anode and cathode circuit. The anode and cathode circuits accommodated about 1.6 litres of liquid. Variable speed pumps were used to circulate the Adelaide tap water through the electrodes. The preliminary test was carried out at room temperature and the external anolyte and catholyte liquid pH were measured at regular intervals. The DC power source was set to current control mode for the test. Electrode material and shape and internal anolyte and catholyte characteristics were not optimized in this preliminary test. The results of the test were:

TABLE 3
Unipolar Activation of Adelaide Tap
Water Using Compound Electrodes

| | Time (minutes) | | | | | |
|---|---|---|---|---|---|---|
| | 0 | 2 | 60 | 120 | 180 | 240 |
| Cell Voltage | 3.26 | 3.10 | 3.26 | 3.34 | 3.62 | 3.57 |
| Cell Amperes | 0.03 | 0.01 | 0.01 | 0.01 | 0.05 | 0.05 |
| Anode Voltage | 1.58 | 1.45 | 1.56 | 1.64 | 1.79 | 1.77 |
| Cathode Volts | 1.71 | 1.67 | 1.72 | 1.73 | 1.84 | 1.83 |
| Anode pH | 7.9 | 8.3 | 8.5 | 8.5 | 8.5 | 8.4 |
| Cathode pH | 7.9 | 8.3 | 8.5 | 8.6 | 8.6 | 8.6 |

The cell current was reduced from 0.03 to 0.01 amperes after the start of the experiment because bubbles were noted in both the anode and cathode internal electrodes indicating reaction was taking place in the internal electrolyte. This is an area where more studies need to be made to ensure that the internal electrolyte acted only as an electron conductor. The experimental results indicated that a chemical reaction occurred within the anolyte and the catholyte and the different reactions was indicated by the difference in the ending pH of the anolyte and catholyte.

The preliminary test indicated that the compound electrode is successful in carrying out electrolytic unipolar activation of liquids. The model that would fit the results is that there is a complete electronic circuit as described above. Since the anode electrode is electro-positive, electrons are removed from the anolyte liquid at the anode cell. Electrons are transferred to the catholyte liquid by the negative cathode electrode. The electrical resistance of the internal solution or the electrolytic membrane is an important variable in the operation of this compound electrode. For a given cell voltage, the higher the electrical resistance of the membrane or internal solution, the more electrons are available at the anode electrode and cathode electrode for unipolar reactions.

A variation of the compound electrode is shown on FIG. 7 where the solution electrode is eliminated and an internal solution or gel or electronic membrane made from polymer or ceramic is in contact with both the anode electrode and the cathode electrode to provide the complete electronic circuit. The electronic membrane allows the flow of electrons from the cathode to the anode electrode only. The anode electrode and the cathode electrode are separated by a common wall that is part of the anode cell and the cathode cell. In a commercial unit, the anode cell and cathode cell may be cubical or cylindrical electrodes and contain the anolyte and catholyte respectively.

The third apparatus for carrying out unipolar activation was developed from the concept of the compound electrodes. If the resistance of the electrolytic membrane or internal electrolyte were made very high such as infinitely high, there will be no electron flow between the anode and cathode electrode via the electrical link. The electron flow will be from the anode electrode to the DC power source and from the DC power source to the cathode electrode. These electrons are used entirely in chemical reactions at the anode cell and in the chemical reactions at the cathode cell. To test this concept, the apparatus shown on FIG. 5 was arranged so that anode electrode and the anode solution electrode were connected and acted as the anode electrode. The same connections were made of the cathode electrode and the cathode solution electrode as shown on FIG. 8. The anode electrode is a 50 mm×288 mm long titanium tube coated with platinum, ruthenium and rhodium and the anode solution electrode connected to the anode electrode has an outside diameter of 38 mm coated with platinum, ruthenium and rhodium. The cathode electrode is exactly the same as the anode electrode. Adelaide tap water was used as the electrolyte and two tests were conducted, one at 9.02 volts and the other at 18.04 volts. The results are shown on Table 4.

TABLE 4
Unipolar Activation Using Separate Electrodes

| | Time, minutes | | | | |
|---|---|---|---|---|---|
| | 0 | 15 | 30 | 45 | 60 |
| Cell Voltage | 9.02 | 9.02 | 9.02 | 9.02 | 9.02 |
| Cell Amperes | 0.00 | 0.00 | 0.00 | 0.00 | 0.00 |
| Anode Temp. C. | 16 | 17 | 18 | 18 | 18 |
| Cathode Temp C. | 17 | 17 | 18 | 18 | 18 |
| Anode pH | 6.7 | 6.7 | 7.0 | 6.8 | 7.0 |
| Cathode pH | 6.2 | 6.0 | 5.9 | 5.5 | 4.2 |
| Cell Voltage | 18.04 | 18.04 | 18.04 | 18.04 | 18.04 |
| Cell Amperes | 0.00 | 0.00 | 0.00 | 0.00 | 0.00 |
| Anode Temp. C. | 16 | 18 | 18 | 18 | 19 |
| Cathode Temp. C. | 17 | 18 | 18 | 18 | 19 |
| Anode pH | 6.9 | 6.9 | 7.1 | 7.2 | 7.2 |
| Cathode pH | 6.7 | 6.9 | 6.9 | 7.0 | 6.7 |

Effort to measure the current was not successful and the current was below the 2 milli-ampere range of the instrument available. The results show that the anode liquid increased in pH (alkaline) while the cathode liquid decreased in pH (acidic). This trend is more pronounced at the lower voltage (9 volts) than at the higher voltage of 18 volts. The trend is also opposite to that shown on Table 1. The difference in unipolar action between Table 1 and Table 4 is that electrons pass through the electrolyte in Table 1 similar to the apparatus of Dr. Bakhir while in Table 4, the electrons do not pass through the electrolyte. The electrolyte was passed at turbulent action in the experiments in Table 4 to ensure that there is no dead spot and that the electrolyte was in good contact with the electrodes.

The results in Table 4 indicate that there may be a different regime of reactions in this type of unipolar activation. There may be less pH active species produced and more pH non-active species. The cell voltage and the nature of the fluids passing through the electrodes or the additives in the fluids would affect the results desired.

In a commercial system, the most appropriate electrodes may be pipes or tubes with surface increasing features such as gauss, or expanded metal, or helical guides inside the electrode with surfaces coated with material for corrosion resistance and low over-voltage characteristics. A diagram of such a commercial unit is shown on FIG. 9 where a DC source 140 is connected to the cylindrical anode electrode 141 and cylindrical cathode electrode 142 with liquid fed to each electrode. Activated anolyte is produced at the anode cell and activated catholyte is produced at the cathode cell.

Throughout this specification various indications have been given as to the scope of this invention but the invention is not limited to any one of these but may reside in two or more of these combined together. The examples are given for illustration only and not for limitation.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

1. A unipolar liquid activation apparatus including an anode cell, a cathode cell, and a direct current power supply,
the anode cell having an anode, a liquid inlet and an anolyte outlet,
the cathode cell having an cathode, a liquid inlet and a catholyte outlet,
means to electrically connect the anode and cathode respectively to the direct current power supply,
means to supply fluid to the anode and cathode cells, and
means to recover the activated anolyte from the anode cell and the activated catholyte from the cathode cell.

2. A unipolar liquid activation apparatus as in claim 1 wherein the anode cell further includes a first solution electrode and the cathode cell includes a second solution electrode and further including means to electrically connect the first solution electrode and the second solution electrode.

3. A unipolar liquid activation apparatus as in claim 1 wherein the anode is a compound anode, the compound anode having an inner anode electrode and an outer electrode being the anode and separated by and in intimate contact with an electrolytic membrane or internal electrolyte, the cathode is a compound cathode, the compound cathode having an inner cathode electrode and a outer electrode being the cathode and separated by and in intimate contact with an electrolytic membrane or internal electrolyte and means to electrically connect the inner anode electrode to the inner cathode electrode.

4. A unipolar liquid activation apparatus as in claim 2 wherein the anode cell and cathode cell are adjacent to each other and the first and second solution electrodes and the means to electrically connect the first solution electrode and the second solution electrode together comprise a common first and second solution electrode being an electronic membrane in contact respectively with the anode and cathode and allowing flow of electrons only from the cathode to the anode.

5. A unipolar liquid activation apparatus as in claim 4 wherein the electrical resistance of the electronic membrane in contact with the anode and cathode electrode is very high resulting in the anode electrode being electrically isolated from the cathode electrode.

6. A unipolar liquid activation apparatus as in claim 1 wherein the anode electrode and the cathode electrode are cylindrical incorporating internal surface enhancement features such as gauze or expanded metal connected to the electrodes.

7. A unipolar liquid apparatus as in claim 6 wherein the positive terminal of the DC power source is connected to the anode electrode and the negative positive terminal of the DC power source is connected to the cathode electrode.

8. A unipolar liquid apparatus as in claim 6 wherein the ends of the anode and cathode electrodes are connected to electrically non-conducting inlet and outlet.

9. A unipolar liquid apparatus as in claims 1 wherein the means to supply fluid to the anode and cathode cells includes means to feed at least one of a liquid, a gas or a solid or a mixture thereof.

10. A unipolar liquid activation apparatus as in claim 1 wherein the means to electrically connect the first solution electrode and the second solution electrode is a wire between the respective cells.

11. A unipolar liquid activation apparatus as in claim 1 wherein the cathode and anode have a high surface area to increase the contact area with the respective liquids.

12. A method of sterilisation of liquid including the step of passing streams of the liquid through respective electrolytic cells, the electrolytic cells being an anode cell having an anode, a liquid inlet and an anolyte outlet and a cathode cell having an cathode, a liquid inlet and a catholyte outlet, a direct current power supply electrically connected to the anode and cathode respectively,
means to supply liquid to the anode and cathode cells, and
means to recover the activated anolyte from the anode cell and the activated catholyte from the cathode cell.
